(19) United States
(12) Patent Application Publication
(10) Pub. No.: US 2025/0334794 A1
(43) Pub. Date: Oct. 30, 2025

(54) OPTICAL SCANNING APPARATUS AND IMAGE FORMING APPARATUS

(71) Applicant: CANON KABUSHIKI KAISHA, Tokyo (JP)

(72) Inventor: Soya SAIJO, Tochigi (JP)

(21) Appl. No.: 19/051,410

(22) Filed: Feb. 12, 2025

(30) Foreign Application Priority Data
Feb. 19, 2024 (JP) 2024-022533

(51) Int. Cl. G02B 26/12; B41J 2/447; B41J 2/47; G03G 15/04; G03G 15/041

(52) U.S. Cl. CPC G02B 26/125; B41J 2/447; B41J 2/471; G03G 15/04036; G03G 15/0415; G02B 26/124

(57) ABSTRACT

An optical scanner includes: deflector deflecting a beam from a light source to scan scanned surface in main-scanning direction; and a first element closest to scanned surface and guides the beam to scanned surface, in which thickness of first element in optical-axis direction in main-scanning section changes in main-scanning direction, first element includes an optical surface whose normal on main-scanning section is tilted thereto, the normal tilt amount changes in main-scanning direction, and a position in main-scanning direction where interval in optical-axis direction between both ends in sub-scanning direction of effective region of the optical surface in sub-scanning section is maximum, a position in main-scanning direction where a thickness in optical-axis direction of first element in main-scanning section is maximum, and maximum image height in main-scanning direction on scanned surface are appropriately set in region on one side of the optical surface relative to optical axis in main-scanning direction.

### BACKGROUND

### Technical Field

The present disclosure relates to an optical scanning apparatus and is particularly suitable for an image forming apparatus such as a laser beam printer (LBP), a digital copier, or a multifunction printer (MFP).

### Description of the Related Art

Conventionally, in order to miniaturize an optical scanning apparatus for a color image forming apparatus, an optical system (sub-scanning oblique incidence system) has been employed in which a plurality of light beams emitted from a plurality of light sources are obliquely incident on a deflector in a sub-scanning cross section.

Japanese Patent Application Laid-Open No. 2010-140011 discloses a technique for correcting curvature of a scanning line and a wavefront aberration in a sub-scanning oblique incidence system by setting an optical surface of an image forming optical element as a sagittal line tilt changing surface.

### SUMMARY

According to an embodiment of the present disclosure, there is provided an optical scanning apparatus including: a deflector that deflects a light beam from a light source to scan a scanned surface in a main scanning direction and an optical system including at least one optical element that guides the light beam from the deflector to the scanned surface, wherein the at least one optical element includes a first optical element that is disposed closest to the scanned surface, wherein a thickness of the first optical element in an optical axis direction in the main scanning cross section changes in the main scanning direction, wherein the first optical element includes an optical surface whose normal on the main scanning cross section is tilted with respect to the main scanning cross section, wherein tilt amount of the normal of the optical surface changes in the main scanning direction, wherein in a region on one side with respect to the optical axis in the main scanning direction of the optical surface, the following inequality is satisfied,

0.0≤|y_{|Δs|max1}−y_{dmax1}|/W1≤0.1

where y_{|Δs|max1} represents a position with respect to the optical axis in the main scanning direction at which an interval in the optical axis direction between one end and the other end of an effective region in a sub-scanning direction of the optical surface is maximum, y_{dmax1} represents a position with respect to the optical axis in the main scanning direction at which a thickness in the optical axis direction of the first optical element in the main scanning cross section is maximum, and W1 represents a maximum image height in the main scanning direction on the scanned surface.

Further features of the present disclosure will become apparent from the following description of exemplary embodiments with reference to the attached drawings.

### BRIEF DESCRIPTION OF THE DRAWINGS

FIG. 1A is a sub-scanning cross-sectional view of the optical scanning apparatus according to a first embodiment.

FIG. 1B is a developed view in a main scanning cross section of the optical scanning apparatus according to the first embodiment.

FIG. 1C is a developed view in a sub-scanning cross section of the optical scanning apparatus according to the first embodiment.

FIG. 2A is a diagram for explaining a sub-scanning cross-sectional view of the image pickup lens according to the first embodiment.

FIG. 2B is a diagram for explaining aberrations |Δs|(y) and d(y) of the image pickup lens according to the first embodiment.

FIG. 3A is a diagram illustrating |Δs|(y) of the image pickup lens according to the first embodiment.

FIG. 3B is a diagram illustrating d(y) of the image pickup lens according to the first embodiment.

FIG. 4 is a diagram illustrating curvature of field of the optical scanning apparatus according to the first embodiment.

FIG. 5 is a diagram illustrating fθ characteristics of the optical scanning apparatus according to the first embodiment.

FIG. 6 is a diagram illustrating a curvature of scanning line of the optical scanning apparatus according to the first embodiment.

FIG. 7 is a diagram illustrating an astigmatism in 45-degree direction of the optical scanning apparatus according to the first embodiment.

FIG. 8 is a diagram illustrating an image plane illuminance distribution of the optical scanning apparatus according to the first embodiment.

FIG. 9A is a sub-scanning cross-sectional view of the optical scanning apparatus according to a second embodiment.

FIG. 9B is a developed view of a main scanning cross section of the optical scanning apparatus according to the second embodiment.

FIG. 9C is a developed view of a sub-scanning cross section of the optical scanning apparatus according to the second embodiment.

FIG. 10A is a diagram illustrating an image plane illuminance distribution of the optical scanning apparatus according to the second embodiment.

FIG. 10B is a diagram illustrating an image plane illuminance distribution of the optical scanning apparatus according to the second embodiment.

FIG. 10C is a diagram illustrating an image plane illuminance distribution of the optical scanning apparatus according to the second embodiment.

FIG. 10D is a diagram illustrating an image plane illuminance distribution of the optical scanning apparatus according to the second embodiment.

FIG. 11 is a sub-scanning cross sectional view of the color image forming apparatus.

### DESCRIPTION OF THE EMBODIMENTS

Hereinafter, an optical scanning apparatus according to the present embodiment will be described in detail with reference to the accompanying drawings. In order to facilitate understanding of the present embodiment, the following drawings may be drawn to a scale different from the actual scale.

In the following description, the main scanning direction (Y direction) is a direction perpendicular to the rotation axis (or oscillation axis) of the deflector and the optical axis (X direction) of the optical system (a direction in which the light beam is reflected and deflected (deflected for scanning) by a rotating polygon mirror). The sub-scanning direction (Z direction) is a direction parallel to the rotation axis (or oscillation axis) of the deflector. The main scanning cross section is a section perpendicular to the sub-scanning direction and including the optical axis. The sub-scanning cross section is a section perpendicular to the main scanning direction.

The present disclosure relates to an optical scanning apparatus, and particularly to an image forming apparatus such as a laser beam printer (LBP), a digital copier, or a multifunction printer (MFP).

Conventionally, in order to miniaturize an optical scanning apparatus for a color image forming apparatus, an optical system (sub-scanning oblique incidence system) has been employed in which a plurality of light beams emitted from a plurality of light sources are obliquely incident on a deflector in a sub-scanning cross section. Japanese Patent Application Laid-Open No. 2010-140011 discloses a technique for correcting a curvature of scanning line and a wavefront aberration in a sub-scanning oblique incidence system by setting an optical surface of an image forming optical element as a sagittal tile changing surface.

However, when the sagittal line tilt changing surface is used as in Japanese Patent Application Laid-Open No. 2010-140011, the thickness of the image forming optical element in the optical axis direction in the sub-scanning cross section becomes uneven in the sub-scanning direction. Therefore, when an amount of birefringence in the sub-scanning cross section of the image forming optical element changes in the sub-scanning direction so that a position of light beam passing through the image forming optical element fluctuates in the sub-scanning direction due to an arrangement error or the like, the optical performance deteriorates.

An advantage of some aspects of the embodiments is to provide an optical scanning apparatus having excellent optical performance.

### First Embodiment

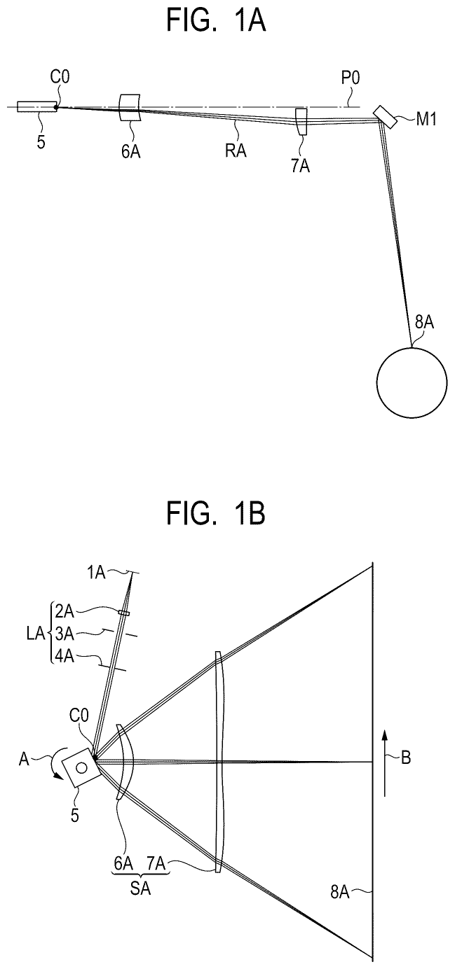

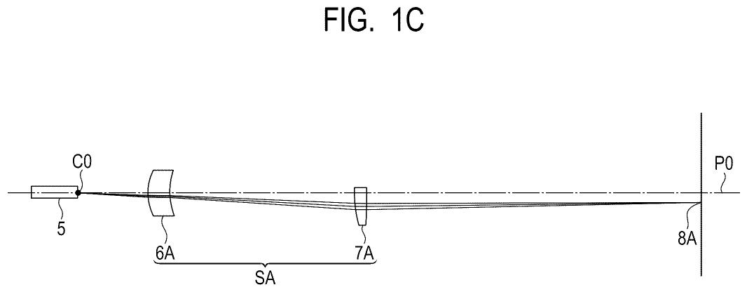

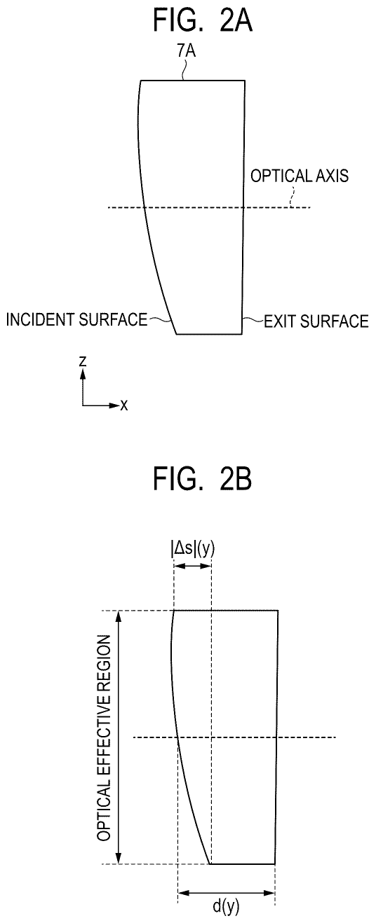

FIGS. 1A, 1B and 1C are a sub-scanning partial cross-sectional view, a developed view in the main scanning partial cross-section, and a developed view in the sub-scanning partial cross-section, respectively, of the optical scanning apparatus 100 according to the first embodiment.

The optical scanning apparatus 100 of the present embodiment includes a light source 1A, an incident optical system LA, a deflector 5, an image forming optical system SA (first optical system), and a reflection mirror (reflection optical element) M1.

The optical scanning apparatus 100 according to the present embodiment uses a so-called sub-scanning oblique incidence optical system in which the light beam RA is deflected by the deflector 5 to scan the scanned surface 8A and the light beam RA is incident on the deflector 5 obliquely in the sub-scanning direction.

As the light source 1A, a semiconductor laser or the like is used. The number of light emitting points of the light source 1A may be one or more.

The incident optical system LA includes an anamorphic lens 2A, a sub-scanning aperture stop 3A, and a main-scanning aperture stop 4A.

The anamorphic lens 2A converts the light beam RA emitted from the light source 1A into a parallel light beam in the main scanning cross section and condenses the parallel light beam in the sub-scanning direction. Here, the parallel light beam includes not only an exact parallel light beam but also a substantially parallel light beam such as a weakly divergent light beam or a weakly convergent light beam. A collimator lens and a cylinder lens may be used instead of the anamorphic lens 2A.

A sub-scanning aperture stop 3A restricts a diameter of the light beam RA having passed through the anamorphic lens 2A in the sub-scanning direction. Similarly, a main scanning aperture stop 4A restricts the light beam diameter in the main scanning direction of the light beam RA having passed through the sub-scanning aperture stop 3A.

The deflector 5 is rotated in a direction of an arrow A in the drawing by a driving unit such as a motor (not shown), so that the deflector 5 deflects the incident light beam RA and scans the scanned surface 8A in a direction of an arrow B in the drawing. The deflector 5 is constituted by, for example, a polygon mirror.

In the image forming optical system SA, the deflected light beam RA deflected and reflected by the deflecting surface 5A of the deflector 5 passes through the image forming lenses (optical elements) 6A and 7A and is then reflected by the reflection mirror M1 to be guided to the scanned surface 8A. The image forming optical system SA includes an image forming lens 7A (first optical element) as an optical element disposed at a position closest to the scanned surface 8A on the optical path of the deflected light beam RA deflected and reflected by the deflecting surface 5A.

The reflection mirror M1 is means for reflecting a light beam, and a vapor deposition mirror or the like is used as the reflection mirror M1. In addition, the effect of the present embodiment is not limited to the number of reflection mirrors, and the number of reflection mirrors may be appropriately changed.

Here, C0 in the drawings is a deflection point (on-axis deflection point) when the principal ray of the on-axis light beam is deflected, and P0 is a plane (reference plane) that passes through the deflection point C0 and is perpendicular to the rotation axis of the deflector 5. The light beam RA incident on the deflecting surface 5a is deflected at the deflection point C0 in the sub-scanning cross section so as to intersect the main scanning cross section. Hereinafter, a length of the optical path from the deflection point C0 to each scanned surface is referred to as an optical path length of each image forming optical system.

Next, specification values, an optical arrangement, and optical surface shapes of the optical scanning apparatus 100 according to the present embodiment are shown in Tables 1 to 3 below. Here, Table 1 shows the specification values and lens arrangements of the incident optical system LA and the image forming optical system SA, and Tables 2 and 3 show optical surface shapes of the incident optical system LA and the image forming optical system SA. It should be noted that a column of the optical arrangement in Table 1 shows the coordinates of the reflection points on each reflection mirror of the light beam RA directed toward a center of image (on-axis image height) in the main scanning direction on the scanned surface 8A.

In Tables 1 and 2, the optical axis direction, an axis orthogonal to the optical axis in the main scanning cross section, and an axis orthogonal to the optical axis in the sub-scanning cross section when an intersection point of each optical surface and the optical axis is defined as the origin are defined as x-axis, y-axis, and z-axis, respectively. Here, a traveling direction of light corresponds to a positive x side in the x-axis, and the light source side with respect to the optical axis corresponds to a positive y side in the y-axis. In Table 3, “E-x” means “×10^{-x}”.

TABLE 1
Specification values

| | | | |
|---|---|---|---|
| laser wavelength | (nm) | λ | 790 |
| incident angle in main scanning direction from incident optical system to deflector | (deg) | αm | 78 |
| incident angle in sub-scanning direction from incident optical system to deflector | (deg) | αs | 2.7 |
| refractive index of anamorphic lens | | n2 | 1.524 |
| refractive index of image forming lens 6 | | n6 | 1.524 |
| refractive index of image forming lens 7 | | n7 | 1.524 |
| diameter of sub-scanning aperture stop (rectangular shape) | (mm) | Z direction | 2.84 |
| diameter of main scanning aperture stop (rectangular shape) | (mm) | Y direction | 3.75 |
| coordinates of rotation axis of polygon mirror | (mm) | X direction | −6.03 |
| (on-axis deflection point of image forming optical system SA being defined as (0, 0, 0) | | Y direction | −3.79 |
| fθ coefficient | (mm/rad) | k | 207 |
| diameter of circumscribed circle of polygon mirror | (mm) | Rp | 20 |
| number of surfaces of polygon mirror | | MEN | 4 |
| maximum scanning angle of view | (deg) | θmax | ±45.12 |
| image height on surface to be scanned | (mm) | W | ±163 |

TABLE 2
optical arrangement (incident optical system LA, image forming optical system SA)

| | | | | | direction of optical axis | | |
|---|---|---|---|---|---|---|---|
| | | coordinate of each surface | | | (described in direction cosine) | | |
| | | x coordinate | y coordinate | z coordinate | x component | y component | z component |
| light source | | 33.582 | 157.991 | 7.617 | 0.208 | 0.977 | 0.047 |
| anamorphic lens | incident surface | 26.606 | 125.171 | 6.035 | 0.208 | 0.977 | 0.047 |
| | exit surface | 25.983 | 122.240 | 5.893 | 0.208 | 0.977 | 0.047 |
| sub-scanning aperture stop | | 22.837 | 107.438 | 5.180 | 0.208 | 0.978 | 0.000 |
| main scanning aperture stop | | 16.633 | 78.253 | 3.773 | 0.208 | 0.978 | 0.000 |
| polygon mirror | deflecting surface | 0.000 | 0.000 | 0.000 | — | — | — |
| image forming lens 6 | incident surface | 26.000 | 0.000 | 0.000 | 1.000 | 0.000 | 0.000 |
| | exit surface | 34.200 | 0.000 | 0.000 | 1.000 | 0.000 | 0.000 |
| image forming lens 7 | incident surface | 100.800 | 0.000 | −5.960 | 1.000 | 0.000 | 0.000 |
| | exit suirface | 105.100 | 0.000 | −5.960 | 1.000 | 0.000 | 0.000 |
| mirror M1 | reflecting surface | 136.419 | 0.000 | −5.337 | 0.650 | 0.000 | 0.760 |

| | | | | | | |
|---|---|---|---|---|---|---|
| surface to be scanned | 149.906 | 0.000 | −100.984 | −0.155 | 0.000 | 0.988 |

TABLE 3
aspherical coefficient

| | | anamorphic lens | | image forming lens 6A | | image forming lens 7A | |
|---|---|---|---|---|---|---|---|
| | | incident | exit | incident | exit | incident | exit |
| | | surface | surface | surface | surface | surface | surface |
| meridian | R | ∞ | 3.7169E+01 | −7.1974E+01 | −4.3211E+01 | −4.0000E+03 | 3.4560E+02 |
| line | K | — | — | 8.9207E−01 | −5.7266E−01 | 0.0000E+00 | −9.0215E+01 |
| | B1 | — | — | 0.0000E+00 | 0.0000E+00 | 0.0000E+00 | 0.0000E+00 |
| | B2 | — | — | 0.0000E+00 | 0.0000E+00 | 0.0000E+00 | 0.0000E+00 |
| | B3 | — | — | 0.0000E+00 | 0.0000E+00 | 0.0000E+00 | 0.0000E+00 |
| | B4 | — | — | −7.6122E−07 | −1.9946E−07 | 0.0000E+00 | −2.1656E−07 |
| | B5 | — | — | 0.0000E+00 | 0.0000E+00 | 0.0000E+00 | 0.0000E+00 |
| | B6 | — | — | 6.7890E−09 | 1.6448E−09 | 0.0000E+00 | 1.8005E−11 |
| | B7 | — | — | 0.0000E+00 | 0.0000E+00 | 0.0000E+00 | 0.0000E+00 |
| | B8 | — | — | −5.8886E−12 | 1.2724E−12 | 0.0000E+00 | −1.0687E−15 |
| | B9 | — | — | 0.0000E+00 | 0.0000E+00 | 0.0000E+00 | 0.0000E+00 |
| | B10 | — | — | 1.6170E−15 | −1.4177E−15 | 0.0000E+00 | 2.9833E−20 |
| sagittal | r | ∞ | 2.6170E+01 | 2.0000E+01 | 2.0586E+01 | 2.6855E+01 | 2.9402E+02 |
| line R | E1 | — | — | 0.0000E+00 | 0.0000E+00 | 0.0000E+00 | 1.9697E−07 |
| | E2 | — | — | 0.0000E+00 | 1.5580E−05 | −5.1442E−06 | −2.3677E−06 |
| | E3 | — | — | 0.0000E+00 | 0.0000E+00 | 0.0000E+00 | −3.4436E−09 |
| | E4 | — | — | 0.0000E+00 | −3.3937E−08 | 0.0000E+00 | −2.4684E−10 |
| | E5 | — | — | 0.0000E+00 | 0.0000E+00 | 0.0000E+00 | 1.4997E−12 |
| | E6 | — | — | 0.0000E+00 | 3.9640E−11 | 0.0000E+00 | 1.6924E−14 |
| | E7 | — | — | 0.0000E+00 | 0.0000E+00 | 0.0000E+00 | −2.5044E−16 |
| | E8 | — | — | 0.0000E+00 | −6.5582E−14 | 0.0000E+00 | −1.7952E−18 |
| | E9 | — | — | 0.0000E+00 | 0.0000E+00 | 0.0000E+00 | 1.4054E−20 |
| | E10 | — | — | 0.0000E+00 | 5.4011E−17 | 0.0000E+00 | 7.1174E−23 |
| sagittal | M(0, 1) | — | — | 0.0000E+00 | −3.9283E−02 | −1.5136E−01 | 1.0716E−02 |
| line non- | M(1, 1) | — | — | 0.0000E+00 | 0.0000E+00 | −5.6381E−06 | 2.9831E−06 |
| circular- | M(2, 1) | — | — | 0.0000E+00 | 3.6758E−05 | −2.6037E−05 | −4.0016E−05 |
| arc | M(3, 1) | — | — | 0.0000E+00 | 0.0000E+00 | 1.3125E−07 | 1.1748E−07 |
| | M(4, 1) | — | — | 0.0000E+00 | 0.0000E+00 | 5.6889E−09 | 7.9090E−09 |
| | M(5, 1) | — | — | 0.0000E+00 | 0.0000E+00 | −3.8269E−11 | −3.1453E−11 |
| | M(6, 1) | — | — | 0.0000E+00 | 0.0000E+00 | 8.3400E−14 | −6.6668E−13 |
| | M(7, 1) | — | — | 0.0000E+00 | 0.0000E+00 | 5.1339E−15 | 3.8471E−15 |
| | M(8, 1) | — | — | 0.0000E+00 | 0.0000E+00 | −2.8936E−17 | 8.3073E−17 |
| | M(9, 1) | — | — | 0.0000E+00 | 0.0000E+00 | −2.2022E−19 | −1.3738E−19 |
| | M(10, 1) | — | — | 0.0000E+00 | 0.0000E+00 | −5.5171E−22 | −5.8207E−21 |
| diffraction | C(2, 2) | −7.8466E−03 | — | — | — | — | — |
| surface | C(0, 2) | −8.6690E−03 | — | — | — | — | — |

Although a temperature compensation is performed by forming a diffraction surface on the incident surface of the anamorphic lens 2A, the effect of the present embodiment is not limited to this configuration. The incident surface of the anamorphic lens 2A is a rotationally asymmetric diffraction surface, and the phase function (P of the diffraction grating is expressed by the following equation (1),

$$Φ = \frac{2 π}{k λ} + {\sum }_{i , j} {C}_{i , j} {y}^{i} {z}^{j} \qquad ( 1 )$$

where, k=1. In addition, λ is a wavelength, and which is assumed here that λ is 790 nm.

The image forming lenses 6A and 7A according to the present embodiment are optical elements made of resin, and the meridian shape of each optical surface (the shape of the optical surface in the main scanning cross section) is an aspheric shape that can be expressed as a function of the position x in the optical axis direction up to the tenth order with respect to the position y in the main scanning direction, as expressed by Expression (2),

$$x = \frac{{y}^{2} / R}{1 + \sqrt{1 - ( 1 + K ) {( y / R )}^{2}}} + {\sum }_{i} {B}_{i} {y}^{i} \qquad ( 2 )$$

where R represents the meridian curvature radius, K represents the eccentricity, and Bi (i=1, 2, . . . , 10) is the aspheric coefficient.

The image forming lenses 6A and 7A according to the present embodiment are optical elements made of a resin material, but are not limited to those made of only a resin, and may contain components other than a resin, such as inorganic fine particles (the main component may be a resin). It is preferable but is not necessarily that the image forming lenses 6A and 7A are made of a resin material, the image forming lenses 6A and 7A can be made of a glass material as necessary.

In addition, in the present specification, the meridian line refers to a shape in a main scanning cross section of the optical element.

The shape of the sagittal line shape (the shape of the optical surface in the sub-scanning cross section at an arbitrary image height (y) and z) of each of the optical surfaces of the image forming lenses 6A and 7A according to the present embodiment is an aspherical shape as expressed by the following Expression (3),

$$S = \frac{{z}^{2} / {r}^{′}}{1 + \sqrt{1 - {( z / {r}^{′} )}^{2}}} + {\sum }_{i \cdot j} {m}_{i , j} {y}^{i} {z}^{j} \qquad ( 3 )$$

where S represents a sagittal line shape defined in the sub-scanning cross section at each position on the meridian line, and m_{i,j} (i=1, 2, . . . , 10 and j=1) represents an aspheric coefficient. A term composed of a first-order function of z is a term that gives a tilt (sagittal-line tilt) amount in the sagittal lime direction. Here, the sagittal line tilt is an inclination of a normal on the main-scanning cross section of the optical surface.

The sagittal radius of curvature r′ is the radius of curvature in the sub-scanning cross section, and continuously changes according to the y-coordinate of the optical surface as described in the following equation (4),

$$\frac{1}{{r}^{′}} = \frac{1}{r} + {\sum }_{i} {E}_{i} {y}^{i} \qquad ( 4 )$$

where r represents the radius of curvature (sagittal radius of curvature) in the sub-scanning cross section on the optical axis, and Ei (i=1, 2, . . . , 10) represents the coefficient of change in the sagittal line.

Next, effects of the optical scanning apparatus 100 according to the present embodiment will be described.

In the optical scanning apparatus 100 according to the present embodiment, the sub-scanning oblique incidence optical system is employed, and it is necessary to correct the curvature of scanning line generated by the sub-scanning oblique incidence optical system and a difference in the wavefront aberration amount in the azimuth ±45-degree direction (astigmatism in 45-degree direction). Therefore, as shown in Tables 2 and 3, the incident surface and the exit surface of the image forming lens (first image forming optical element) 7A according to the present embodiment are made to include the aspherical coefficients m_{i,1}(≠0), so that the correction is performed on the sagittal line tilt changing surface in which the sagittal line tilt amount changes in the main scanning direction (y-axis direction).

Note that, in the present specification, the sagittal line tilt changing surface is an optical surface in which the sagittal line tilt amount changes from the on-axis position to the off-axis position.

The incident surface and the exit surface of the image forming lens 7A according to the present embodiment are formed of a sagittal line tilt changing surface inclined in directions different from each other with respect to a plane perpendicular to the optical axis in the shape in the sub-scanning cross section.

When the sagittal line tilt changing surface is used, the curvature of scanning line can be corrected by appropriately setting the sagittal line tilt amount at each light beam passing position and controlling the irradiation position on the scanned surface 8A. Further, similarly, by setting the inclination of the optical surface in accordance with the inclination of the incident wavefront, it is possible to correct the astigmatism in 45-degree direction. In other words, by setting the two surfaces of the incident surface and the exit surface to be the sagittal line tilt changing surface, both of the curvature of scanning line and the astigmatism in 45-degree direction are satisfactorily corrected.

However, as a result of correcting the curvature of scanning line and the astigmatism in 45-degree direction, when the sagittal line tilt of the incident surface and the sagittal line tilt of the exit surface have mutually different signs as shown in FIG. 2A, the image forming lens 7A has a shape (uneven thickness shape) in which the thickness in the optical axis direction is uneven in the sub-scanning cross section. When a lens having such a uneven thickness shape is molded by injection molding, the birefringence amount generally differs in the sub-scanning direction. Then, since the birefringence fluctuates when the passing position of the light beam passing through the image forming lens 7A fluctuates in the sub-scanning direction due to an assembly error or the like of the image forming lens 7A, the optical performance also fluctuates and may deteriorate. When a laser is used for the light source 1A, the polarization state of the light beam RA changes due to birefringence, the reflectance of the light beam also changes due to the polarization reflection characteristic of the reflection mirror M1, and as a result, unevenness in the amount of light on the scanned surface 8A occurs.

Therefore, when the position y in the main scanning direction on the optical surface is divided into a positive region (y≥0, region on one side) and a negative region (y<0, region on the opposite side), the optical surface of the image forming lens 7A according to the present embodiment satisfies the inequality (5) in at least one region,

$$0. \leq \vert {y}_{\vert Δ s \vert max} - {y}_{dmax} \vert / W \leq 0.1 \qquad ( 5 )$$

where y_{|Δs|max} represents y (a position with respect to the optical axis in the main scanning direction) at which |Δs|(y) is maximized when |Δs|(y) is an interval (absolute value of a difference in position) in the optical axis direction of one end and the other end in the sub-scanning direction of the optical surface effective region in the sub-scanning cross section at a position y in the main scanning direction on the optical surface, y_{dmax} represents y (a position with respect to the optical axis in the main scanning direction) at which the thickness (d(y)) in the optical axis direction on the meridian line of the image forming lens at the position y in the main scanning direction becomes maximum, and w represents the maximum image height (outermost off-axis image height) in the main scanning direction on the scanned surface.

More specifically, in a region on one side with respect to the optical axis in the main scanning direction of the sagittal line tilt changing surface, the following inequality is satisfied,

$$0. \leq \vert {y}_{\vert Δ s \vert max 1} - {y}_{d max 1} \vert / W 1 \leq 0.1$$

where y_{|Δs|max1} represents a position with respect to the optical axis in the main scanning direction at which an interval in the optical axis direction between one end and the other end of the effective region of the sagittal line tilt changing surface in the sub-scanning direction in the sub-scanning cross section is maximum, y_{dmax1} represents a position with respect to the optical axis in the main scanning direction at which a thickness in the optical axis direction of the image forming lens 7A in the main scanning cross section is maximum, and W1 represents the maximum image height on one side in the main scanning direction on the scanned surface.

In addition, in the region on the opposite side to the one side with respect to the optical axis in the main scanning direction of the sagittal line tilt changing surface, the following inequality is satisfied,

$$0. \leq \vert {y}_{\vert Δ s \vert max 2} - {y}_{d max 2} \vert / W 2 \leq 0.1$$

where y_{|Δs|max2} represents a position with respect to the optical axis in the main scanning direction at which an interval in the optical axis direction between one end and the other end of the effective region of the sagittal line tilt changing surface in the sub-scanning direction in the sub-scanning cross section is the maximum, y_{dmax2} represents a position with respect to the optical axis in the main scanning direction at which a thickness in the optical axis direction of the image forming lens 7A in the main scanning cross section is the maximum, and W2 represents the maximum image height on the opposite side in the main scanning direction on the scanned surface.

Here, W=163 mm (scanning width being 326 mm on the scanned surface). y_{|Δs|max} and y_{dmax} are illustrated in FIG. 2B.

Note that the optical surface effective region is a region (light beam use region) through which a light beam passes on the optical surface of the optical element in design, and a region appropriately set in consideration of a variation in passing position of the light beam due to a manufacturing error, an assembly error, or the like of the optical element. Here, the width of the optical surface effective region in the sub-scanning direction is set to 6 mm (±3 mm from the optical axis) on contrast to the width of the light beam use region in the sub-scanning direction of 3 mm (±1.5 mm from the optical axis).

In the optical scanning apparatus 100 of the present embodiment, the inequality (5) is satisfied and the sagittal line tilt changing surface is designed so that a y position at which |Δs|(y) of the optical surface is large and a y position at which the thickness in the optical axis direction on the meridian line is large are close to each other in the y direction. By satisfying the inequality (5), the thickness in the optical axis direction on the meridian line is made thick to form a thickness deviation shape by a sagittal line tilt that reduces the thickness deviation ratio, and the difference in the amount of birefringence generated in the sub-scanning direction is reduced. Here, the thickness deviation ratio is a ratio of the maximum thickness to the minimum thickness in the optical axis direction of the optical element. As a result, variation in optical performance due to birefringence can also be suppressed, and deterioration in optical performance can be suppressed, while the curvature of scanning line and the astigmatism in 45-degree direction are satisfactorily corrected by using the sagittal line tilt changing surface.

If the inequality (5) is not satisfied, the thickness deviation ratio becomes large and the difference in the amount of birefringence generated in the sub-scanning direction becomes large, so that the fluctuation of the optical performance due to the assembly error becomes large and the optical performance deteriorates.

It is more preferable that inequality (5a) is satisfied.

$$0. \leq \vert {y}_{\vert Δ s \vert max} - {y}_{d max} \vert / W \leq 0.05 \qquad ( 5 a )$$

Furthermore, when the position y in the main scanning direction is divided into a positive region and a negative region, it is more preferable that the inequality (5) or the inequality (5a) is satisfied in both regions.

Further, it is more preferable that both the incident surface and the exit surface of the image forming lens 7A satisfy inequality (5) or inequality (5a).

Further, the optical surfaces of the image forming lens 7A according to the present embodiment satisfies the inequality (6) in at least one of a positive region where a position y in the main scanning direction on the optical surface is positive (y≥0) and a negative region where a position y in the main scanning direction on the optical surface is negative (y<0).

$$0. \leq \vert {y}_{\vert Δ s \vert max} - {y}_{d max} \vert / \vert {y}_{max} \vert \leq 0.12 \qquad ( 6 )$$

Here, yₘₐₓ represents the y position (a position with respect to the optical axis in the main scanning direction) of the end portion in the main scanning direction of the optical surface effective region of the image forming lens 7A.

More specifically, in a region on one side with respect to the optical axis in the main scanning direction of the sagittal line tilt changing surface, the following inequality is satisfied,

$$0. \leq \vert {y}_{\vert Δ s \vert max 1} - {y}_{d max 1} \vert {y}_{max 1} \vert \leq 0.12$$

where y_{|Δs|max1} represents a position with respect to the optical axis in the main scanning direction at which an interval in the optical axis direction between one end and the other end of the effective region of the sagittal line tilt changing surface in the sub-scanning direction in the sub-scanning cross section is maximum, y_{dmax1} represents a position with respect to the optical axis in the main scanning direction at which a thickness in the optical axis direction of the image forming lens 7A in the main scanning cross section is maximum, and yₘₐₓ₁ represents a position of an end portion on the one side in the main scanning direction of the effective region of the sagittal line tilt changing surface with respect to the optical axis in the main scanning direction.

In addition, in a region on the opposite side to the one side with respect to the optical axis in the main scanning direction of the sagittal line tilt changing surface, the following inequality is satisfied,

$$0. \leq \vert {y}_{\vert Δ s \vert max 2} - {y}_{d max 2} \vert / \vert {y}_{max 2} \vert \leq 0.12$$

where y_{|Δs|max2} represents a position with respect to the optical axis in the main scanning direction at which an interval in the optical axis direction between one end and the other end in the sub-scanning direction of the effective region of the sagittal line tilt changing surface in the sub-scanning cross section is maximum, y_{dmax2} represents a position with respect to the optical axis in the main scanning direction at which a thickness in the optical axis direction of the image forming lens 7A in the main scanning cross section is maximum, and yₘₐₓ₂ represents a position of the end portion of the effective region of the sagittal line tilt changing surface on the opposite side in the main scanning direction with respect to the optical axis in the main scanning direction.

Here, yₘₐₓ=90 mm (width of the optical surface effective region in the main scanning direction being 180 mm). The width of the light beam use region in the main scanning direction is 170 mm (a range of ±85 mm from the optical axis position).

If the value is out of the upper limit or the lower limit of the inequality (6), the thickness deviation ratio is large and the difference in the amount of birefringence generated in the sub-scanning direction is large, so that the fluctuation of the optical performance due to the assembly error is large, and the optical performance deteriorates.

It is more preferable that the inequality (6a) described below is satisfied.

$$0. \leq \vert {y}_{\vert Δ s \vert max} - {y}_{d max} \vert / \vert {y}_{max} \vert \leq 0.09 \qquad ( 6 a )$$

Further, it is more preferable that the inequality (6b) described below is satisfied.

$$0. \leq \vert {y}_{\vert Δ s \vert max} - {y}_{d max} \vert / \vert {y}_{max} \vert \leq 0.06 \qquad ( 6 b )$$

Furthermore, when the position y in the main scanning direction is divided into a positive region and a negative region, it is more preferable that the inequality (6), (6a), or (6b) is satisfied in both regions.

Although the above description has been given of the sagittal line tilt changing surface for correcting the curvature of scanning line and the astigmatism in 45-degree direction generated when the sub-scanning oblique incidence optical system is employed, the present embodiment is not limited to the sub-scanning oblique incidence optical system and can be applied to any image forming optical system including the sagittal line tilt changing surface. For example, in a so-called deflecting surface incident optical system in which the light beam is incident perpendicularly to the rotation axis of the deflector in the sub-scanning cross section, a ghost is generated by reflection on the optical surface of the image forming lens. The present embodiment can also be applied to a configuration in which the ghost optical path is controlled by setting at least one surface of the optical surfaces of the image forming lens as the sagittal line tilt changing surface so that the ghost does not reach the scanned surface.

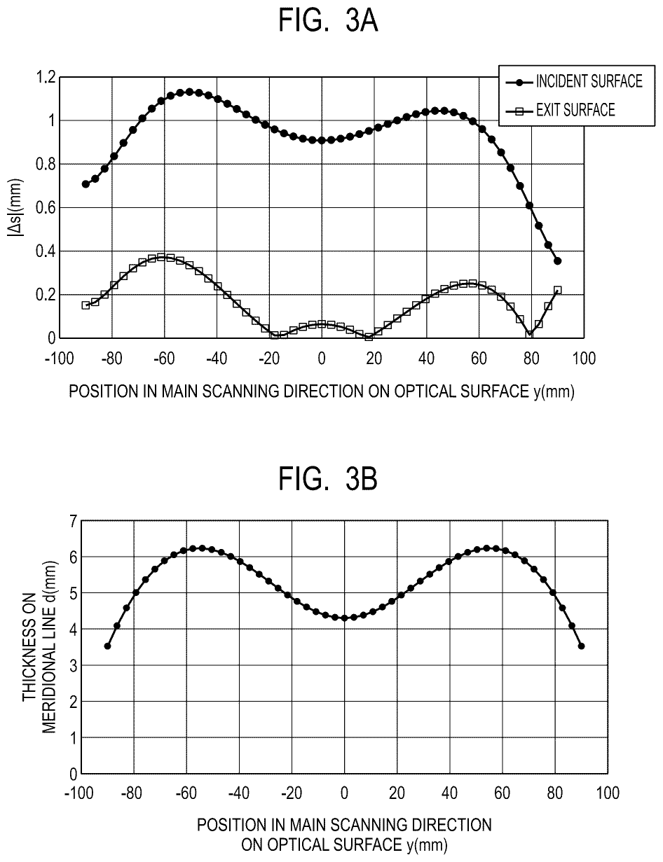

FIGS. 3A and 3B respectively show |Δs|(y) and d(y) on the optical surface of the image forming lens 7A according to the present embodiment. In addition, numerical values of y_{|Δs|max}, y_{dmax}, yₘₐₓ, W, |y_{|Δs|max}−y_{dmax}|, |y_{|Δs|max}−y_{dmax}|/W, and |y_{|Δs|max}−y_{dmax}|/|yₘₐₓ are shown in Table 4. As shown in Table 4, the image forming lens 7A according to the present embodiment satisfies the inequality (5) in both the regions where the position y in the main scanning direction is positive (y≥0) and the region where the position y in the main scanning direction is negative (y<0) on both the incident surface and the exit surface.

Further, as shown in Table 4, the image forming lens 7A according to the present embodiment satisfies the inequality (6) in both of the regions where the position y in the main scanning direction is positive (y≥0) and the region where the position y in the main scanning direction is negative (y<0).

In addition, as shown in Table 4, the value of |y_{|Δs|max}−y_{dmax}| is approximately 11 mm at most.

TABLE 4

| | image forming lens 7A | | | |
|---|---|---|---|---|
| | incident surface | | exit surface | |
| | region | region | region | region |
| | y ≥ 0 | y < 0 | y ≥ 0 | y < 0 |
| y_{\|Δs\|max} | 43.20 | −50.40 | 57.60 | −61.20 |
| y_{dmax} | 54.00 | −54.00 | 54.00 | −54.00 |
| yₘₐₓ | 90.00 | −90.00 | 90.00 | −90.00 |
| W | 163.00 | −163.00 | 163.00 | −163.00 |
| \|y_{Δs\|max} − y_{dmax}\| | 10.80 | 3.60 | 3.60 | 7.20 |
| (y_{Δs\|max} − y_{dmax})/W | −0.07 | −0.02 | 0.02 | 0.04 |
| (y_{Δs\|max} − y_{dmax})/yₘₐₓ | −0.12 | −0.04 | 0.04 | 0.08 |
| \|Δs\|(y_{\|Δs\|max}) | 1.04 | 1.13 | 0.25 | 0.37 |

As shown in Table 4, the maximum value |Δs|(y_{|Δs|max}) (mm) of the interval in the optical axis direction between the one end and the other end in the sub-scanning direction of the effective region of the sagittal line tilt changing surface in the sub-scanning cross section satisfies the inequality (7).

$$0.2 \leq \vert Δ s \vert ( {y}_{\vert Δ s \vert max} ) \leq 1.2 \qquad ( 7 )$$

If the value falls below the lower limit of the inequality (7), the absolute value of the sagittal line tilt amount is small, which makes it impossible to sufficiently correct the curvature of scanning line and the astigmatism in 45-degree direction, thereby deteriorating the optical performance. On the other hand, when the value exceeds the upper limit of the inequality (7), the absolute value of the sagittal amount is large and the thickness deviation ratio is large, so that the amount of change in birefringence in the sub-scanning direction is large and the optical performance deteriorates.

Furthermore, it is more preferable that the following inequality (7a) is satisfied.

$$0.23 \leq \vert Δ s \vert ( {y}_{\vert Δ s \vert max} ) \leq 1.15 \qquad ( 7 a )$$

As shown in Table 3, the exit surface of the image forming lens (second imaging optical element) 6A according to the present embodiment is set to be the sagittal line tilt changing surface. It is possible to change the angle of the light beam RA to be emitted in the main scanning direction by the sagittal line tilt changing surface, and the curvature of scanning line on the incident surface of the image forming lens 7A generated in the sub-scanning oblique incidence optical system is corrected. By performing correction so that the scanning line on the incident surface of the image forming lens 7A passes through the vicinity of the meridian line, it is possible to reduce the influence of the birefringence fluctuation in the sub-scanning direction due to the sagittal line tilt changing surface of the image forming lens 7A, and to reduce the deterioration of the optical performance.

Next, the optical performance of the optical scanning apparatus 100 according to the present embodiment will be described.

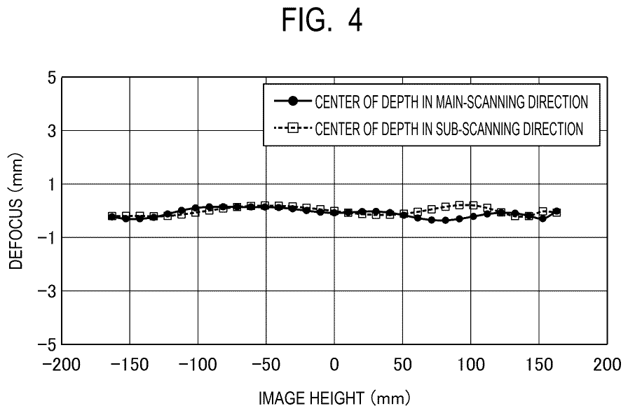

FIG. 4 is a graph showing curvature of field in the main scanning direction and the sub-scanning direction of the optical scanning apparatus 100 according to the present embodiment. As shown in FIG. 4, in the optical scanning apparatus 100 according to the present embodiment, the curvature of field in the main scanning direction and the sub-scanning direction is satisfactorily corrected.

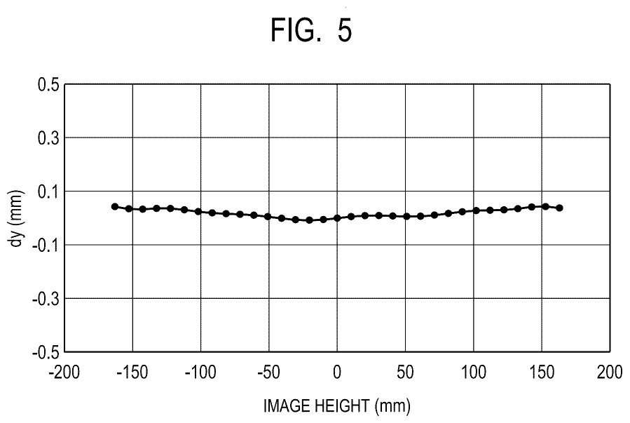

FIG. 5 is a graph showing the fθ characteristic dy of the optical scanning apparatus 100 according to the present embodiment. The fθ characteristic dy indicates a difference obtained by subtracting the ideal image height from the position where the light beam actually reaches. As shown in FIG. 5, it can be seen that the fθ characteristic dy is satisfactorily corrected in the optical scanning apparatus 100 according to the present embodiment.

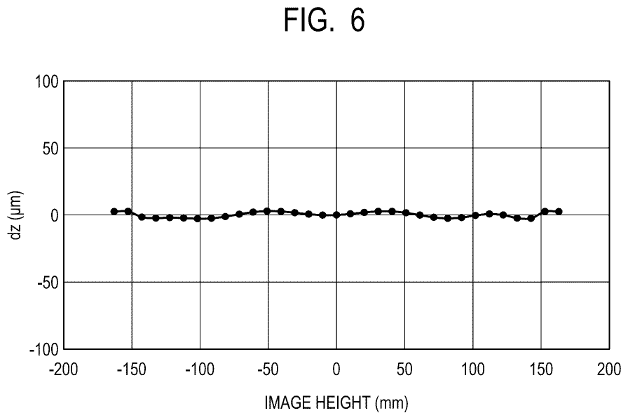

FIG. 6 shows the image height dependency of the curvature of scanning line dz on the scanned surface 8A of the optical scanning apparatus 100 according to the present embodiment. Here, the curvature of scanning line dz means a difference between an image forming position in the sub-scanning direction at each image height and an image forming position in the sub-scanning direction at an axial image height on the scanned surface 8A. As shown in FIG. 6, in the optical scanning apparatus 100 according to the present embodiment, it can be seen that the curvature of scanning line is satisfactorily corrected.

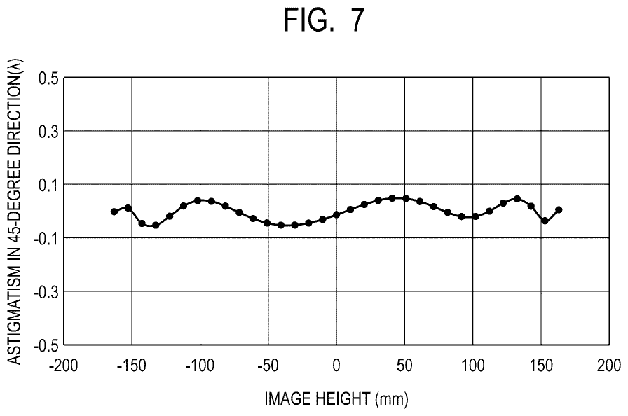

FIG. 7 shows a wavefront aberration amount difference (astigmatism in 45-degree direction) in the azimuth ±45° direction of the optical scanning apparatus 100 according to the present embodiment. As shown in FIG. 7, it can be seen that the optical scanning apparatus 100 according to the present embodiment corrects the astigmatism in 45-degree direction satisfactorily.

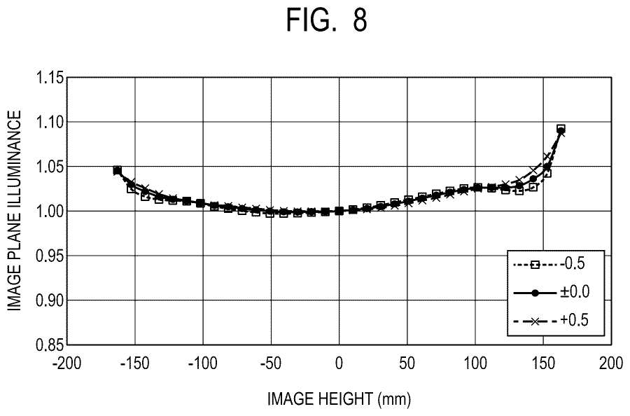

FIG. 8 shows the image height dependency (image plane illuminance distribution) of the amount of light on the scanned surface 8A of the optical scanning apparatus 100 according to the present embodiment. Here, normalization is performed such that the amount of light at an image height of 0 mm is set to 1. In addition, the image plane illuminance distribution when the image forming lens 7A according to the present embodiment is moved by ±0.0 mm, +0.5 mm, and −0.5 mm in the sub-scanning direction is also shown.

As shown in FIG. 8, the variation of the image plane illuminance is within +10% with respect to that on the optical axis, and the variation of the amount of light on the scanned surface 8A is sufficiently suppressed. In order to further suppress fluctuations in the amount of light on the scanned surface 8A, an electrical correction unit that adjusts the amount of light of the light source 1A based on the image plane illuminance distribution measured in advance may be used. Further, in the optical scanning apparatus 100 according to the present embodiment, even if the light beam RA passing through the image forming lens 7A fluctuates by ±0.5 mm due to an assembly error or the like, the fluctuation of the image plane illuminance at each image height is 0.02 or less at the maximum, and the change of the image plane illuminance distribution is sufficiently reduced.

When the above-described electric correction unit is used, if the variation of the image plane illuminance distribution is large for each optical scanning apparatus, it is necessary to individually apply a correction coefficient for correcting the light amount for each optical scanning apparatus. However, since the correction unit becomes complicated, the manufacturing cost of the optical scanning apparatus becomes high. Alternatively, even if a uniform correction coefficient is applied, the correction residual of the image plane illuminance distribution becomes large. In the optical scanning apparatus 100 according to the present embodiment, since a change in the image plane illuminance distribution due to an assembly error or the like is sufficiently reduced, even when the image plane illuminance distribution is corrected by an electric correction unit using a uniform correction coefficient, the correction residual can be reduced and an electric correction unit having a simple configuration can be used.

As described above, in the optical scanning apparatus 100 according to the present embodiment, the fluctuation of the optical performance due to the birefringence is suppressed, and the deterioration of the optical performance is reduced while the curvature of scanning line and the astigmatism in 45-degree direction are satisfactorily corrected.

### Second Embodiment

Hereinafter, an optical scanning apparatus 200 according to a second embodiment of the present disclosure will be described.

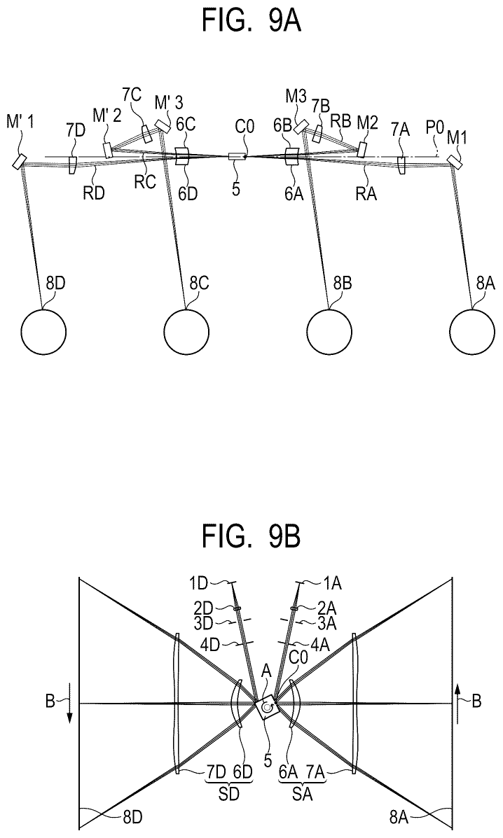

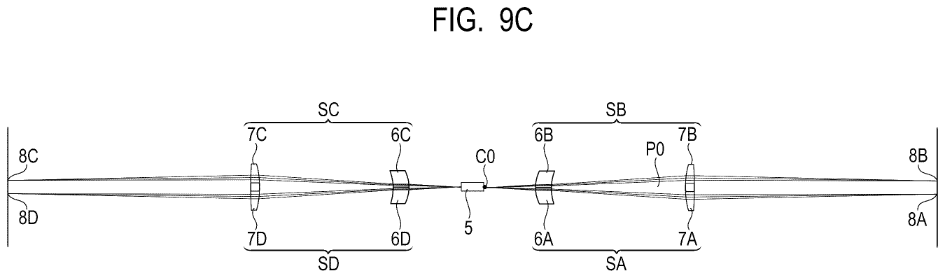

FIG. 9A is a partial sub-scanning cross-sectional view of the optical scanning apparatus 200 according to the second embodiment. FIG. 9B is a partial main scanning cross-sectional development view of the optical scanning apparatus 200 according to the second embodiment. FIG. 9C is a partial sub-scanning cross-sectional development view of the optical scanning apparatus 200 according to the second embodiment.

The optical scanning apparatus 200 according to the present embodiment is different from the optical scanning apparatus 100 according to the first embodiment in that four scanned surfaces 8A, 8B, 8C, and 8D can be simultaneously scanned by a common deflector 5.

The optical scanning apparatus 200 according to the present embodiment includes light sources 1A, 1B, 1C, and 1D, incidence optical systems LA, LB, LC, and LD, a deflector 5, image forming optical systems SA, SB, SC, and SD, and reflection mirrors M1, M2, M3, M′1, M′2, and M′3.

A semiconductor laser or the like is used for each of the light sources 1A, 1B, 1C, and 1D in the same manner as the light source 1A according to the first embodiment. The number of light emitting points of the light sources 1A, 1B, 1C, and 1D may be one or more.

Each of the incident optical systems LA, LB, LC, and LD in the present embodiment has the same configuration and optical action as the incident optical system LA according to the first embodiment except that the combinations of oblique incident angles in the main scanning direction and the sub-scanning direction are different from each other. Members such as an optical element and a diaphragm may be integrated between adjacent optical systems. For example, the main scanning aperture stop 4A and the main scanning aperture stop 4B may be integrated to form a single aperture stop having one aperture.

The light beams RA and RB emitted from a light source 1A (first light source) and a light source 1B (second light source) are incident on the deflecting surface 5a of the deflector 5 via an incident optical system (first incident optical system) LA and an incident optical system (second incident optical system) LB. The light beams RC and RD emitted from light sources 1C and 1D are incident on the deflecting surface 5b of the deflector 5 via incident optical systems LC and LD. At this time, the deflecting surface 5a on which the light beams RA and RB from the light sources 1A and 1B are incident and the deflecting surface 5b on which the light beams RC and RD from the light sources 1C and 1D are incident are different from each other at the same time.

The incident optical systems LA and LB are disposed so that the optical axes thereof are inclined with respect to the main scanning cross section so that the light beams RA and RB are obliquely incident on the deflecting surface 5a in the sub-scanning cross section. Accordingly, the optical paths of the light beams RA and RB can be separated and guided to the corresponding scanned surfaces 8A and 8B. In the present embodiment, in order to equalize the optical performance in the respective optical paths, the absolute values of the oblique incidence angles of the optical axes of the incident optical systems LA and LB with respect to the main scanning cross section are equal to each other, and the signs thereof are different from each other. However, at least one of the absolute values of the optical axes being equal to each other and the sign of the inclination angles of the optical axes being different from each other need to be satisfied, and the absolute values may be different from each other or the signs may be equal to each other as necessary. The same applies to the incident optical systems LC and LD.

Each of the image forming lenses 6A and 6B is an image forming lens similar to the image forming lens 6A according to the first embodiment. Each of the image forming lenses 7A and 7B is an image forming lens similar to the image forming lens 7A according to the first embodiment. Each of the exit surfaces of the image forming lenses 6A and 6B is a multi-stage toric surface composed of two toric surfaces arranged in the sub-scanning direction. The image forming lens 6A and the image forming lens 7A constitute an image forming optical system SA, and the image forming lens 6B and the image forming lens 7B constitute an image forming optical system SB. The image forming optical systems SC and SD have the same configuration as the image forming optical systems SA and SB.

The reflection mirror M1 is disposed between the image forming lens 7A and the scanned surface 8A, the reflection mirror M2 is disposed between the image forming lens 6B and the image forming lens 7B, and the reflection mirror M3 is disposed between the image forming lens 7B and the scanned surface 8B. The light beam RA emitted from the light source 1A and deflected by the deflecting surface 5a is guided to the scanned surface (first scanned surface) 8A via the image forming lens 6A, the image forming lens 7A, and the reflection mirror M1 in this order.

The light beam RB emitted from the light source 1B and deflected by the deflecting surface 5a is guided to the scanned surface (second scanned surface) 8B via the image forming lens 6B, the reflection mirror M2, the image forming lens 7B, and the reflection mirror M3 in this order. The reflection mirrors M′1, M′2, and M′3 are similarly disposed, and the light beam RD emitted from the light source 1D and deflected by the deflecting surface 5b is guided to the scanned surface 8D via the image forming lens 6D, the image forming lens 7D, and the reflection mirror M′1 in this order. The light beam RC emitted from the light source 1C and deflected by the deflecting surface 5b is guided to the scanned surface 8C via the image forming lens 6C, the reflecting mirror M′2, the image forming lens 7C, and the reflecting mirror M′3 in this order.

Here, in each of both sides of the deflector 5, an optical path reaching the scanned surfaces 8A and 8D spatially (physically) disposed on a side far from the deflector 5 is referred to as an “outer optical path”, and an optical path reaching the scanned surfaces 8B and 8C spatially disposed on a side close to the deflector 5 is referred to as an “inner optical path”. At this time, only one reflection mirror is disposed in the outer optical path, and two reflection mirrors are disposed in the inner optical path. In this way, by making the number of reflective elements different between the outer optical path and the inner optical path, it is possible to avoid interference between each optical element and the optical path while matching the optical path lengths in all the optical paths, and to realize easy manufacturing. However, the number of reflection mirrors is not limited to this, and may be appropriately determined according to the interval between the scanned surfaces, the arrangement of the image forming elements, and the like.

The specification values, the optical arrangement, and the optical surface shapes of the optical scanning apparatus 200 according to the present embodiment are shown in Tables 5 to 11 below. Here, Tables 5 to 9 show specification values and lens arrangements of the incident optical systems LA to LD and the image forming optical systems SA to SD, and Tables 10 and 11 show optical surface shapes of the incident optical systems LA to LD and the image forming optical systems SA to SD.

TABLE 5
Specification values

| | | | |
|---|---|---|---|
| laser wavelength | (nm) | λ | 790 |
| incident angle in main scanning direction from incident optical system to deflector | (deg) | αm | 78 |
| incident angle in sub-scanning direction from incident optical system to deflector | (deg) | αs | ±2.7 |
| refractive index of anamorphic lens | | n 2 | 1.524 |
| refractive index of image forming lens 6 | | n 6 | 1.524 |
| refractive index of image forming lens 7 | | n 7 | 1.524 |
| diameter of sub-scanning aperture stop (rectangular shape) | (mm) | Z direction | 2.84 |
| diameter of main scanning aperture stop (rectangular shape) | (mm) | Y direction | 2.70 |
| coordinates of rotation axis of polygon mirror | (mm) | X direction | −6.03 |
| (on-axis deflection point of image forming optical system SA being defined as (0, 0, 0) | | Y direction | −3.79 |
| fθ coefficient | (mm/rad) | k | 220 |
| diameter of circumscribed circle of polygon mirror | (mm) | Rp | 20 |
| number of surfaces of polygon mirror | | MEN | 4 |
| maximum scanning angle of view | (deg) | θmax | ±42.45 |
| image height on surface to be scanned | (mm) | W | ±163 |

TABLE 6
optical arrangement (incident optical system LA, image forming optical system SA)

| | | | | | direction of optical axis | | |
|---|---|---|---|---|---|---|---|
| | | coordinate of each surface | | | (described in direction cosine) | | |
| | | x coordinate | y coordinate | z coordinate | x component | y component | z component |
| light source | | 33.582 | 157.991 | 7.617 | 0.208 | 0.977 | 0.047 |
| anamorphic lens | incident surface | 26.606 | 125.171 | 6.035 | 0.208 | 0.977 | 0.047 |
| | exit surface | 25.983 | 122.240 | 5.893 | 0.208 | 0.977 | 0.047 |
| sub-scanning aperture stop | | 22.837 | 107.438 | 5.180 | 0.208 | 0.978 | 0.000 |
| main scanning aperture stop | | 16.633 | 78.253 | 3.773 | 0.208 | 0.978 | 0.000 |
| polygon mirror | deflecting surface | 0.000 | 0.000 | 0.000 | 1.000 | 0.000 | 0.000 |
| image forming lens 6 | incident surface | 26.000 | 0.000 | 0.000 | 1.000 | 0.000 | 0.000 |
| | exit surface | 34.200 | 0.000 | 0.000 | 1.000 | 0.000 | 0.000 |
| image forming lens 7 | incident surface | 100.800 | 0.000 | −5.960 | 1.000 | 0.000 | 0.000 |
| | exit suirface | 105.100 | 0.000 | −5.960 | 1.000 | 0.000 | 0.000 |
| mirror M1 | reflecting surface | 136.419 | 0.000 | −5.337 | 0.650 | 0.000 | 0.760 |

| | | | | | | |
|---|---|---|---|---|---|---|
| surface to be scanned | 149.906 | 0.000 | −100.984 | −0.155 | 0.000 | 0.988 |

TABLE 7
optical arrangement (incident optical system LB, image forming optical system SB)

| | | | | | direction of optical axis | | |
|---|---|---|---|---|---|---|---|
| | | coordinate of each surface | | | (described in direction cosine) | | |
| | | x coordinate | y coordinate | z coordinate | x component | y component | z component |
| light source | | 33.582 | 157.991 | −7.617 | 0.208 | 0.977 | −0.047 |
| anamorphic lens | incident surface | 26.606 | 125.171 | −6.035 | 0.208 | 0.977 | −0.047 |
| | exit surface | 25.983 | 122.240 | −5.893 | 0.208 | 0.977 | −0.047 |
| sub-scanning aperture stop | | 22.837 | 107.438 | −5.180 | 0.208 | 0.978 | 0.000 |
| main scanning aperture stop | | 16.633 | 78.253 | −3.773 | 0.208 | 0.978 | 0.000 |
| polygon mirror | deflecting surface | 0.000 | 0.000 | 0.000 | 1.000 | 0.000 | 0.000 |
| image forming lens 6 | incident surface | 26.000 | 0.000 | 0.000 | 1.000 | 0.000 | 0.000 |
| | exit surface | 34.200 | 0.000 | 0.000 | 1.000 | 0.000 | 0.000 |
| mirror M2 | reflecting surface | 74.351 | 0.000 | 4.215 | 0.987 | 0.000 | −0.160 |
| image forming lens 7 | incident surface | 49.811 | 0.000 | 14.233 | 0.949 | 0.000 | −0.316 |
| | exit suirface | 45.731 | 0.000 | 15.593 | 0.949 | 0.000 | −0.316 |
| mirror M3 | reflecting surface | 38.150 | −3.500 | 17.849 | 0.646 | 0.000 | −0.763 |

| | | | | | | |
|---|---|---|---|---|---|---|
| surface to be scanned | 54.906 | 0.000 | −100.984 | 0.155 | 0.000 | −0.988 |

TABLE 8
optical arrangement (incident optical system LC, image forming optical system SC)

| | | | | | direction of optical axis | | |
|---|---|---|---|---|---|---|---|
| | | coordinate of each surface | | | (described in direction cosine) | | |
| | | x coordinate | y coordinate | z coordinate | x component | y component | z component |
| light source | | −45.642 | 157.991 | −7.617 | −0.208 | 0.977 | −0.047 |
| anamorphic lens | incident surface | −38.666 | 125.171 | −6.035 | −0.208 | 0.977 | −0.047 |
| | exit surface | −38.043 | 122.240 | −5.893 | −0.208 | 0.977 | −0.047 |
| sub-scanning aperture stop | | −34.897 | 107.438 | −5.180 | −0.208 | 0.978 | 0.000 |
| main scanning aperture stop | | −28.693 | 78.253 | −3.773 | −0.208 | 0.978 | 0.000 |
| polygon mirror | deflecting surface | −12.060 | 0.000 | 0.000 | −1.000 | 0.000 | 0.000 |
| image forming lens 6 | incident surface | −38.060 | 0.000 | 0.000 | −1.000 | 0.000 | 0.000 |
| | exit surface | −46.260 | 0.000 | 0.000 | −1.000 | 0.000 | 0.000 |
| mirror M2 | reflecting surface | −89.568 | 0.000 | 4.419 | −0.984 | 0.000 | −0.176 |
| image forming lens 7 | incident surface | −68.250 | 0.000 | 13.930 | −0.938 | 0.000 | −0.346 |
| | exit suirface | −64.216 | 0.000 | 15.419 | −0.938 | 0.000 | −0.346 |
| mirror M3 | reflecting surface | −56.747 | −3.500 | 17.903 | −0.520 | 0.000 | −0.854 |

| | | | | | | |
|---|---|---|---|---|---|---|
| surface to be scanned | −40.094 | 0.000 | −100.984 | 0.123 | 0.000 | −0.992 |

TABLE 9
optical arrangement (incident optical system LD, image forming optical system SD)

| | | | | | direction of optical axis | | |
|---|---|---|---|---|---|---|---|
| | | coordinate of each surface | | | (described in direction cosine) | | |
| | | x coordinate | y coordinate | z coordinate | x component | y component | z component |
| light source | | −45.642 | 157.991 | 7.617 | −0.208 | 0.977 | 0.047 |
| anamorphic lens | incident surface | −38.666 | 125.171 | 6.035 | −0.208 | 0.977 | 0.047 |
| | exit surface | −38.043 | 122.240 | 5.893 | −0.208 | 0.977 | 0.047 |
| sub-scanning aperture stop | | −34.897 | 107.438 | 5.180 | −0.208 | 0.978 | 0.000 |
| main scanning aperture stop | | −28.693 | 78.253 | 3.773 | −0.208 | 0.978 | 0.000 |
| polygon mirror | deflecting surface | −12.060 | 0.000 | 0.000 | −1.000 | 0.000 | 0.000 |
| image forming lens 6 | incident surface | −38.060 | 0.000 | 0.000 | −1.000 | 0.000 | 0.000 |
| | exit surface | −46.260 | 0.000 | 0.000 | −1.000 | 0.000 | 0.000 |
| image forming lens 7 | incident surface | −112.860 | 0.000 | −5.960 | −1.000 | 0.000 | 0.000 |
| | exit suirface | −117.160 | 0.000 | −5.960 | −1.000 | 0.000 | 0.000 |
| mirror M1 | reflecting surface | −148.491 | 5.000 | −5.337 | −0.749 | 0.000 | 0.662 |

| | | | | | | |
|---|---|---|---|---|---|---|
| surface to be scanned | −135.094 | 0.000 | −100.984 | −0.123 | 0.000 | 0.992 |

TABLE 10
aspherical coefficient

| | | anamorphic lens | | image forming lenses 6A, 6C | | image forming lenses 6B, 6D | |
|---|---|---|---|---|---|---|---|
| | | incident | exit | incident | exit | incident | exit |
| | | surface | surface | surface | surface | surface | surface |
| meridian | R | ∞ | 3.7169E+01 | −7.1974E+01 | −4.3211E+01 | −7.1974E+01 | −4.3211E+01 |
| line | K | — | — | 8.9207E−01 | −5.7266E−01 | 8.9207E−01 | −5.7266E−01 |
| | B1 | — | — | 0.0000E+00 | 0.0000E+00 | 0.0000E+00 | 0.0000E+00 |
| | B2 | — | — | 0.0000E+00 | 0.0000E+00 | 0.0000E+00 | 0.0000E+00 |
| | B3 | — | — | 0.0000E+00 | 0.0000E+00 | 0.0000E+00 | 0.0000E+00 |
| | B4 | — | — | −7.6122E−07 | −1.9946E−07 | −7.6122E−07 | −1.9946E−07 |
| | B5 | — | — | 0.0000E+00 | 0.0000E+00 | 0.0000E+00 | 0.0000E+00 |
| | B6 | — | — | 6.7890E−09 | 1.6448E−09 | 6.7890E−09 | 1.6448E−09 |
| | B7 | — | — | 0.0000E+00 | 0.0000E+00 | 0.0000E+00 | 0.0000E+00 |
| | B8 | — | — | −5.8886E−12 | 1.2724E−12 | −5.8886E−12 | 1.2724E−12 |
| | B9 | — | — | 0.0000E+00 | 0.0000E+00 | 0.0000E+00 | 0.0000E+00 |
| | B10 | — | — | 1.6170E−15 | −1.4177E−15 | 1.6170E−15 | −1.4177E−15 |
| sagittal | r | ∞ | 2.6170E+01 | 2.0000E+01 | 2.0586E+01 | 2.0000E+01 | 2.0586E+01 |
| line R | E1 | — | — | 0.0000E+00 | 0.0000E+00 | 0.0000E+00 | 0.0000E+00 |
| | E2 | — | — | 0.0000E+00 | 1.5580E−05 | 0.0000E+00 | 1.5580E−05 |
| | E3 | — | — | 0.0000E+00 | 0.0000E+00 | 0.0000E+00 | 0.0000E+00 |
| | E4 | — | — | 0.0000E+00 | −3.3937E−08 | 0.0000E+00 | −3.3937E−08 |
| | E5 | — | — | 0.0000E+00 | 0.0000E+00 | 0.0000E+00 | 0.0000E+00 |
| | E6 | — | — | 0.0000E+00 | 3.9640E−11 | 0.0000E+00 | 3.9640E−11 |
| | E7 | — | — | 0.0000E+00 | 0.0000E+00 | 0.0000E+00 | 0.0000E+00 |
| | E8 | — | — | 0.0000E+00 | −6.5582E−14 | 0.0000E+00 | −6.5582E−14 |
| | E9 | — | — | 0.0000E+00 | 0.0000E+00 | 0.0000E+00 | 0.0000E+00 |
| | E10 | — | — | 0.0000E+00 | 5.4011E−17 | 0.0000E+00 | 5.4011E−17 |
| sagittal | M(0, 1) | — | — | 0.0000E+00 | −3.9283E−02 | 0.0000E+00 | 3.9283E−02 |
| line non- | M(1, 1) | — | — | 0.0000E+00 | 0.0000E+00 | 0.0000E+00 | 0.0000E+00 |
| circular- | M(2, 1) | — | — | 0.0000E+00 | 3.6758E−05 | 0.0000E+00 | −3.6758E−05 |
| arc | M(3, 1) | — | — | 0.0000E+00 | 0.0000E+00 | 0.0000E+00 | 0.0000E+00 |
| | M(4, 1) | — | — | 0.0000E+00 | 0.0000E+00 | 0.0000E+00 | 0.0000E+00 |
| | M(5, 1) | — | — | 0.0000E+00 | 0.0000E+00 | 0.0000E+00 | 0.0000E+00 |
| | M(6, 1) | — | — | 0.0000E+00 | 0.0000E+00 | 0.0000E+00 | 0.0000E+00 |
| | M(7, 1) | — | — | 0.0000E+00 | 0.0000E+00 | 0.0000E+00 | 0.0000E+00 |
| | M(8, 1) | — | — | 0.0000E+00 | 0.0000E+00 | 0.0000E+00 | 0.0000E+00 |
| | M(9, 1) | — | — | 0.0000E+00 | 0.0000E+00 | 0.0000E+00 | 0.0000E+00 |
| | M(10, 1) | — | — | 0.0000E+00 | 0.0000E+00 | 0.0000E+00 | 0.0000E+00 |
| diffraction | C(2, 2) | −7.8466E−03 | — | — | — | — | — |
| surface | C(0, 2) | −8.6690E−03 | — | — | — | — | — |

TABLE 11
aspherical coefficient

| | | image forming lenses 7A, 7B | | image forming lenses 7C, 7D | |
|---|---|---|---|---|---|
| | | incident | exit | incident | exit |
| | | surface | surface | surface | surface |
| meridian | R | −4.0000E+03 | 3.4560E+02 | −4.0000E+03 | 3.4560E+02 |
| line | K | 0.0000E+00 | −9.0215E+01 | 0.0000E+00 | −9.0215E+01 |
| | B1 | 0.0000E+00 | 0.0000E+00 | 0.0000E+00 | 0.0000E+00 |
| | B2 | 0.0000E+00 | 0.0000E+00 | 0.0000E+00 | 0.0000E+00 |
| | B3 | 0.0000E+00 | 0.0000E+00 | 0.0000E+00 | 0.0000E+00 |
| | B4 | 0.0000E+00 | −2.1656E−07 | 0.0000E+00 | −2.1656E−07 |
| | B5 | 0.0000E+00 | 0.0000E+00 | 0.0000E+00 | 0.0000E+00 |
| | B6 | 0.0000E+00 | 1.8005E−11 | 0.0000E+00 | 1.8005E−11 |
| | B7 | 0.0000E+00 | 0.0000E+00 | 0.0000E+00 | 0.0000E+00 |
| | B8 | 0.0000E+00 | −1.0687E−15 | 0.0000E+00 | −1.0687E−15 |
| | B9 | 0.0000E+00 | 0.0000E+00 | 0.0000E+00 | 0.0000E+00 |
| | B10 | 0.0000E+00 | 2.9833E−20 | 0.0000E+00 | 2.9833E−20 |
| sagittal | r | 2.6855E+01 | 2.9402E+02 | 2.6855E+01 | 2.9402E+02 |
| line R | E1 | 0.0000E+00 | 1.9697E−07 | 0.0000E+00 | 1.9697E−07 |
| | E2 | −5.1442E−06 | −2.3677E−06 | −5.1442E−06 | −2.3677E−06 |
| | E3 | 0.0000E+00 | −3.4436E−09 | 0.0000E+00 | −3.4436E−09 |
| | E4 | 0.0000E+00 | −2.4684E−10 | 0.0000E+00 | −2.4684E−10 |
| | E5 | 0.0000E+00 | 1.4997E−12 | 0.0000E+00 | 1.4997E−12 |
| | E6 | 0.0000E+00 | 1.6924E−14 | 0.0000E+00 | 1.6924E−14 |
| | E7 | 0.0000E+00 | −2.5044E−16 | 0.0000E+00 | −2.5044E−16 |
| | E8 | 0.0000E+00 | −1.7952E−18 | 0.0000E+00 | −1.7952E−18 |
| | E9 | 0.0000E+00 | 1.4054E−20 | 0.0000E+00 | 1.4054E−20 |
| | E10 | 0.0000E+00 | 7.1174E−23 | 0.0000E+00 | 7.1174E−23 |
| sagittal | M(0, 1) | −1.5136E−01 | 1.0716E−02 | 1.5136E−01 | −1.0716E−02 |
| line | M(1 ,1) | −5.6381E−06 | 2.9831E−06 | 5.6381E−06 | −2.9831E−06 |
| non- | M(2, 1) | −2.6037E−05 | −4.0016E−05 | 2.6037E−05 | 4.0016E−05 |
| circular- | M(3, 1) | 1.3125E−07 | 1.1748E−07 | −1.3125E−07 | −1.1748E−07 |
| arc | M(4, 1) | 5.6889E−09 | 7.9090E−09 | −5.6889E−09 | −7.9090E−09 |
| | M(5, 1) | −3.8269E−11 | −3.1453E−11 | 3.8269E−11 | 3.1453E−11 |
| | M(6, 1) | 8.3400E−14 | −6.6668E−13 | −8.3400E−14 | 6.6668E−13 |
| | M(7, 1) | 5.1339E−15 | 3.8471E−15 | −5.1339E−15 | −3.8471E−15 |
| | M(8, 1) | −2.8936E−17 | 8.3073E−17 | 2.8936E−17 | −8.3073E−17 |
| | M(9, 1) | −2.2022E−19 | −1.3738E−19 | 2.2022E−19 | 1.3738E−19 |
| | M(10, 1) | −5.5171E−22 | −5.8207E−21 | 5.5171E−22 | 5.8207E−21 |

The incident surface and the exit surface of each of the image forming lenses 7A, 7B, 7C, and 7D of the present embodiment are formed of a sagittal line tilt changing surface inclined in directions different from each other with respect to a plane perpendicular to the optical axis in the shape in the sub-scanning cross section.

Next, effects of the optical scanning apparatus 200 according to the present embodiment will be described. In the optical scanning apparatus 200 according to the present embodiment, |Δs|(y), d(y), y_{|Δs|max}, y_{dmax}, yₘₐₓ, W, |y_{|Δs|max}−y_{dmax}|, |y_{|Δs|max}−y_{dmax}|/W, and |y_{|Δs|max}−y_{dmax}|/y_{dmax}, curvature of field in the main scanning direction and the sub-scanning direction, fθ characteristic dy, curvature of scanning line dz, and astigmatism in 45-degree direction are the same as those in the optical scanning apparatus 100 according to the first embodiment, and thus description thereof is omitted.

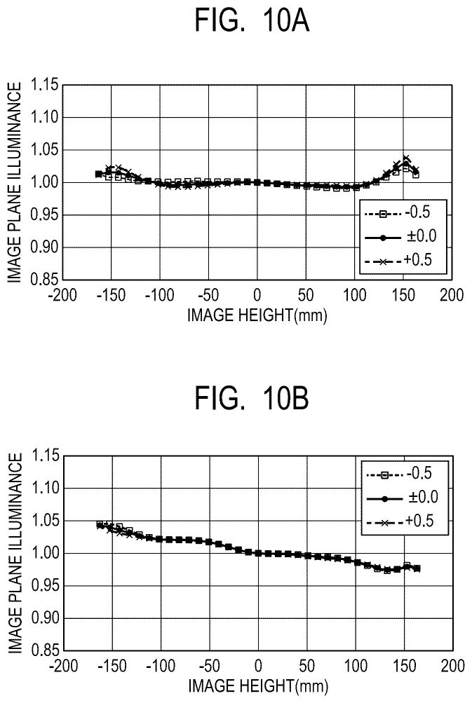

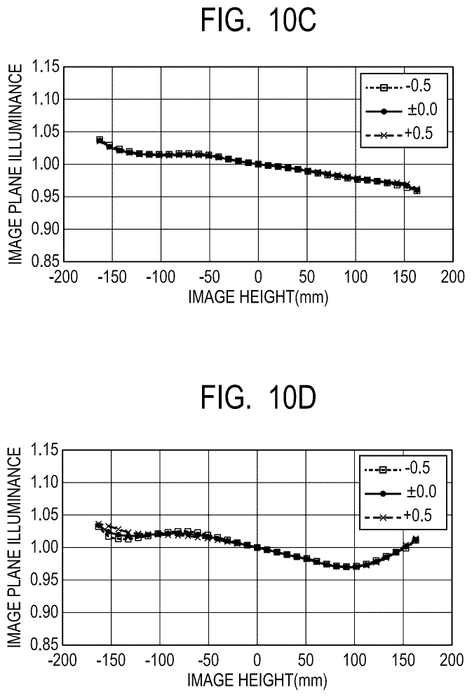

FIGS. 10A to 10D show the image height dependency (image plane illuminance distribution) of the amount of light on the scanned surface of the optical scanning apparatus 200 according to the present embodiment. FIGS. 10A to 10D show image plane illuminance distributions on the scanned surfaces 8A to 8D. Here, normalization is performed such that the amount of light of the central image height in the main scanning direction on each scanned surface is set to 1. The image plane illuminance distributions when the image forming lenses 7A, 7B, 7C, and 7D according to the present embodiment are moved by ±0.0 mm, +0.5 mm, and −0.5 mm in the sub-scanning direction are also shown.

As shown in FIGS. 10A to 10D, the variation in the image plane illuminance is within ±10% to that on the optical axis, and the variation in the amount of light on the scanned surface is sufficiently suppressed. In addition, in order to further suppress the fluctuation of the amount of light on the scanned surface, an electrical correction unit that adjusts the amount of light of the light source based on the image plane illuminance distribution measured in advance may be used. In the optical scanning apparatus 200 according to the present embodiment, even if the light beam passing through the image forming lenses 7A, 7B, 7C, and 7D fluctuates by ±0.5 mm due to an assembly error or the like, the fluctuation of the image plane illuminance at each image height is 0.01 or less at the maximum, and the change of the image plane illuminance distribution is sufficiently reduced.

### [Image Forming Apparatus]

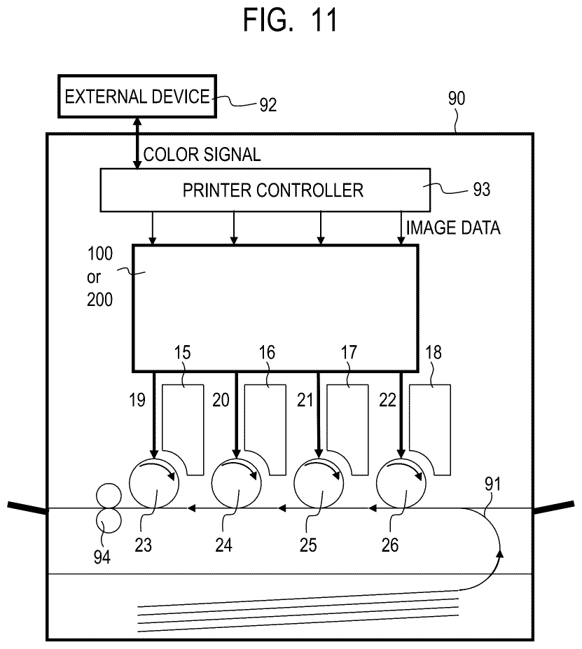

FIG. 11 is a sub-scanning cross-sectional view of a main part of a color image forming apparatus 90 on which the optical scanning apparatus 100 according to the first embodiment or the optical scanning apparatus 200 according to the second embodiment is mounted.

The color image forming apparatus 90 can employ a configuration including four optical scanning apparatus 100 according to the first embodiment or a configuration including one optical scanning apparatus 200 according to the second embodiment and is a color image forming apparatus that records image information on each photosensitive drum surface serving as an image bearing member.

The color image forming apparatus 90 includes the optical scanning apparatus 100 according to the first embodiment or the optical scanning apparatus 200 according to the second embodiment, photosensitive drums (photosensitive members) 23, 24, 25, and 26 as image bearing members, and developing devices 15, 16, 17, and 18. The color image forming apparatus 90 includes a conveyance belt 91, a printer controller 93, and a fixing device 94.

Each color signal (code data) of R (red), G (green), and B (blue) output from an external device 92 such as a personal computer is input to the color image forming apparatus 90.

The input color signal is converted into image data (dot data) of C (cyan), M (magenta), Y (yellow), and K (black) by the printer controller 93 in the color image forming apparatus 90.

The converted image data is input to the optical scanning apparatus 100 or 200. Light beams 19, 20, 21, and 22 modulated according to the image data are emitted from the optical scanning apparatus 100 or 200, and the photosensitive surfaces of the photosensitive drums 23, 24, 25, and 26 are exposed by these light beams.

Charging rollers (not shown) for uniformly charging surfaces of the photosensitive drums 23, 24, 25, and 26 are provided so as to be in contact with the surfaces. The surfaces of the photosensitive drums 23, 24, 25, and 26 charged by the charging rollers are irradiated with light beams 19, 20, 21, and 22 by the optical scanning apparatus 100 or 200.

As described above, the light beams 19, 20, 21, and 22 are modulated based on the image data of each color, and electrostatic latent images are formed on the surfaces of the photosensitive drums 23, 24, 25, and 26 by irradiating the light beams 19, 20, 21, and 22. The formed electrostatic latent image is developed as a toner image by the developing devices 15, 16, 17, and 18 disposed so as to be in contact with the photosensitive drums 23, 24, 25, and 26.

The toner images developed by the developing devices 15 to 18 are multiply transferred onto a sheet (transfer material) (not shown) conveyed on a conveyance belt 91 by transfer rollers (transfer devices) (not shown) disposed so as to face the photosensitive drums 23 to 26, thereby forming a full-color image.

As described above, the sheet on which the unfixed toner image has been transferred is further conveyed to the fixing device 94 behind (on the left side in FIG. 11) the photosensitive drums 23, 24, 25, and 26. The fixing device 94 includes a fixing roller having a fixing heater (not shown) therein and a pressure roller disposed so as to be in pressure contact with the fixing roller. The sheet conveyed from the transfer unit is heated while being pressed by a pressure contact portion between the fixing roller and the pressure roller, whereby the unfixed toner image on the sheet is fixed. Further, a discharge roller (not shown) is disposed behind the fixing roller, and the discharge roller discharges the fixed sheet to the outside of the color image forming apparatus 90.

The color image forming apparatus 90 uses the optical scanning apparatus 100 or 200 to record image signals (image information) on photosensitive surfaces of the photosensitive drums 23, 24, 25, and 26 corresponding to respective colors of C, M, Y, and K, and prints a color image at high speed.

As the external device 92, for example, a color image reading device including a CCD sensor may be used. In this case, the color image reading apparatus and the color image forming apparatus 90 constitute a color digital copier.

While the embodiments of the present invention have been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-022533, filed Feb. 19, 2024, which is hereby incorporated by reference herein in its entirety.

What is claimed is:

1. An optical scanning apparatus, comprising:
a deflector that deflects a light beam from a light source to scan a scanned surface in a main scanning direction; and
an optical system including at least one optical element that guides the light beam from the deflector to the scanned surface,
wherein the at least one optical element includes a first optical element that is disposed closest to the scanned surface,
wherein a thickness of the first optical element in an optical axis direction in the main scanning cross section changes in the main scanning direction,
wherein the first optical element includes an optical surface whose normal on the main scanning cross section is tilted with respect to the main scanning cross section,
wherein tilt amount of the normal of the optical surface changes in the main scanning direction,
wherein in a region on one side with respect to the optical axis in the main scanning direction of the optical surface, the following inequality is satisfied,
$$0. \leq \vert {y}_{\vert Δ s \vert max 1} - {y}_{d max 1} \vert / W 1 \leq 0.1$$
where y_{|Δs|max1} represents a position with respect to the optical axis in the main scanning direction at which an interval in the optical axis direction between one end and the other end of an effective region in a sub-scanning direction of the optical surface is maximum, y_{dmax1} represents a position with respect to the optical axis in the main scanning direction at which a thickness in the optical axis direction of the first optical element in the main scanning cross section is maximum, and W1 represents a maximum image height in the main scanning direction on the scanned surface.

2. The optical scanning apparatus according to claim 1, wherein in a region opposite to the one side with respect to the optical axis in the main scanning direction of the optical surface, the following inequality is satisfied,
$$0. \leq \vert {y}_{\vert Δ s \vert max 2} - {y}_{d max 2} \vert / W 2 \leq 0.1$$
where y_{|Δs|max2} represents a position with respect to the optical axis in the main scanning direction at which the interval in the optical axis direction between one end and the other end of the effective region of the optical surface in the sub-scanning direction is maximum, y_{dmax2} represents a position with respect to the optical axis in the main scanning direction at which the thickness in the optical axis direction of the first optical element in the main scanning cross section is maximum, and W2 represents when a maximum image height in the main scanning direction on the scanned surface.

3. An optical scanning apparatus, comprising: a deflector that deflects a light beam from a light source to scan a scanned surface in a main scanning direction; and an optical system including at least one optical element that guides a light beam from the deflector to the scanned surface,
wherein the at least one optical element includes a first optical element that is disposed closest to the scanned surface and is made of a resin material,
wherein a thickness of the first optical element in the optical axis direction in the main scanning cross section changes in the main scanning direction,
wherein the first optical element includes an optical surface whose normal on the main scanning cross section is tilted with respect to the main scanning cross section,
wherein tilt amount of the normal of the optical surface changes in the main scanning direction,
wherein in a region on one side with respect to the optical axis in the main scanning direction of the optical surface, the following inequality is satisfied,
$$0. \leq \vert {y}_{\vert Δ s \vert max 1} - {y}_{d max 1} \vert / \vert {y}_{max 1} \vert \leq 0.12$$
where y_{|Δs|max1} represents a position with respect to the optical axis in the main scanning direction at which an interval in the optical axis direction between one end and the other end of the effective region of the optical surface in the sub-scanning direction is maximum, y_{dmax1} represents a position with respect to the optical axis in the main scanning direction at which the thickness of the first optical element in the optical axis direction in the main scanning cross section is maximum, and yₘₐₓ₁ represents a position with respect to the optical axis in the main scanning direction of an end portion of the effective region in the main scanning direction of the optical surface.

4. The optical scanning apparatus according to claim 3, wherein in a region opposite to the one side with respect to the optical axis in the main scanning direction of the optical surface, the following inequality is satisfied, a position with respect to the optical axis in the main scanning direction at which an interval between one end and the other end in the optical axis direction of the effective region in the sub-scanning direction of the optical surface becomes maximum is ydΔsdmax2, and a position with respect to the optical axis in the main scanning direction at which a thickness in the optical axis direction of the first optical element in the main scanning cross section becomes maximum is ydmax2, when a position of an end portion in the main scanning direction of the effective region of the optical surface with respect to the optical axis in the main scanning direction is defined as ymax1,
$$0. \leq \vert {y}_{\vert Δ s \vert max 2} - {y}_{d max 2} \vert / \vert {y}_{max 2} \vert \leq 0.12$$
where y_{|Δs|max2} represents a position with respect to the optical axis in the main scanning direction at which the interval in the optical axis direction between one end and the other end of the effective region in the sub-scanning direction of the optical surface is maximum, y_{dmax2} represents a position with respect to the optical axis in the main scanning direction at which the thickness in the optical axis direction of the first optical element in the main scanning cross section is maximum, and yₘₐₓ₂ represents a position with respect to the optical axis in the main scanning direction of an end portion in the main scanning direction of the effective region of the optical surface.

5. The optical scanning apparatus according to claim 1, wherein an incident surface and an exit surface of the first optical element are the optical surfaces.

6. The optical scanning apparatus according to claim 5, wherein the incident surface and the exit surface are inclined in directions different from each other with respect to a plane perpendicular to the optical axis in a shape in a sub-scanning cross section.

7. The optical scanning apparatus according to claim 1, wherein the optical surface satisfies the following inequality,
$$0.2 \leq \vert Δ s \vert ( {y}_{\vert Δ s \vert max} ) \leq 1.2$$
where |Δs(y_{|Δs|max}) represents a maximum value in unit of mm of an interval in the optical axis direction between one end and the other end of the effective region of the optical surface in the sub-scanning direction.

8. The optical scanning apparatus according to claim 1, comprising an incidence optical system configured to cause a light beam from the light source to be obliquely incident on the deflector in a sub-scanning cross section.

9. The optical scanning apparatus according to claim 1, wherein the at least one optical element includes a second optical element disposed closer to the deflector than the first optical element on the optical path of the light beam,
wherein at least one of an incident surface or an exit surface of the second optical element is the optical surface.

10. The optical scanning apparatus according to claim 1, wherein the deflector deflects the light beams from the first and second light sources to scan the first and second scanned surfaces in a main scanning direction.

11. The optical scanning apparatus according to claim 10, comprising first and second incidence optical systems that cause light beams from the first and second light sources to be obliquely incident on the deflector at angles different from each other in the sub-scanning cross section.

12. The optical scanning apparatus according to claim 11, wherein the first and second incidence optical systems cause light beams from the first and second light sources to be obliquely incident on the deflector from sides, with respect to the main scanning cross section including the deflector, different from each other.

13. An optical scanning apparatus, comprising: a deflector that deflects a light beam from a light source to scan a scanned surface in a main scanning direction; and an optical system including at least one optical element that guides a light beam from the deflector to the scanned surface,
wherein the at least one optical element includes a first optical element that is disposed closest to the scanned surface and is made of a resin material,
wherein a thickness of the first optical element in the optical axis direction in the main scanning cross section changes in the main scanning direction,
wherein the first optical element includes an optical surface.

14. An image forming apparatus comprising: the optical scanning apparatus according to claim 1; and a developing device configured to develop an electrostatic latent image formed on the scanned surface by the optical scanning apparatus.

15. An image forming apparatus comprising: the optical scanning apparatus according to claim 1; and a controller configured to convert a code data output from an external device into an image signal and input the image signal to the optical scanning apparatus.
